(19) United States
(12) Patent Application Publication
(10) Pub. No.: US 2019/0120570 A1
(43) Pub. Date: Apr. 25, 2019

(54) HEAT EXCHANGER

(71) Applicant: TOYOTA JIDOSHA KABUSHIKI KAISHA, Toyota-shi (JP)

(72) Inventor: Yohei KINOSHITA, Shizuoka-shi (JP)

(73) Assignee: TOYOTA JIDOSHA KABUSHIKI KAISHA, Toyota-shi (JP)

(21) Appl. No.: 16/135,412

(22) Filed: Sep. 19, 2018

(30) Foreign Application Priority Data
Oct. 23, 2017 (JP) 2017-204627

(51) Int. Cl. F28F 13/16; F28D 21/00; H01T 23/00; F28D 1/02

(52) U.S. Cl. CPC F28F 13/16; F28D 21/00; H01T 23/00; F28D 2001/0253; F28D 2021/0028; F28F 2265/24; F28D 1/024

(57) ABSTRACT

A heat exchanger comprising an ion wind generating part configure to generate an ion wind having directionality charged positive or negative, a heat exchanging part provided at an upstream side in the direction of flow of the ion wind and configured to exchange heat with the ion wind, and a charge removing part provided at a downstream side in the direction of flow of the ion wind and electrically neutralizing the ion wind exchanged in heat with the heat exchanging part.

### CROSS-REFERENCE TO RELATED APPLICATION

This application claims priority based on Japanese Patent Application No. 2017-204627 filed with the Japan Patent Office on Oct. 23, 2017, the entire contents of which are incorporated into the present specification by reference.

### FIELD

The present disclosure relates to a heat exchanger.

### BACKGROUND

Japanese Patent Publication No. 02-037286A discloses a heat exchanger provided with an ion wind generating part generating an ion wind and a heat exchanging part (radiator or condenser) exchanging heat with the ion wind.

### SUMMARY

However, in the configuration of the above-mentioned conventional heat exchanger, the ion wind exchanged in heat with the heat exchanging part, that is, the ion wind passing through the heat exchanging part, flows to the back of the heat exchanging part as it is. For this reason, if there is some sort of part behind the heat exchanging part, that part is struck by the ion wind and charge gradually builds up. If this is so, for example, when mounting the above-mentioned conventional heat exchanger, charge is liable to build up at various car mounted parts present behind the radiator or condenser of the heat exchanging part or at the car body. Further, if charge builds up at a car mounted part, the electronic components built into the car mounted part are liable to malfunction. Further, if charge builds up at the car body, static electricity is liable to be generated.

The present disclosure was made focusing on this problem and has as its object to keep ion wind from striking a part present behind the heat exchanging part and to keep charge from building up.

To solve the above problem, the heat exchanger according to one aspect of the present disclosure is provided with an ion wind generating part configured to generate an ion wind having directionality charged positive or negative, a heat exchanging part provided at an upstream side in the direction of flow of the ion wind and configured to exchange heat with the ion wind, and a charge removing part provided at a downstream side in the direction of flow of the ion wind and electrically neutralizing the ion wind exchanged in heat with the heat exchanging part.

According to the heat exchanger according to this aspect of the present disclosure, it is possible to electrically neutralize the ion wind exchanged in heat with the heat exchanging part, so it is possible to keep ion wind from striking a part present behind the heat exchanging part and to keep charge from building up.

### BRIEF DESCRIPTION OF DRAWINGS

FIG. 1 is a schematic view of the configuration of a heat exchanger according to an embodiment of the present disclosure.

### DESCRIPTION OF EMBODIMENTS

Below, embodiments of the present disclosure will be explained in detail with reference to the drawings. Note that in the following explanation, similar components will be assigned the same reference notations.

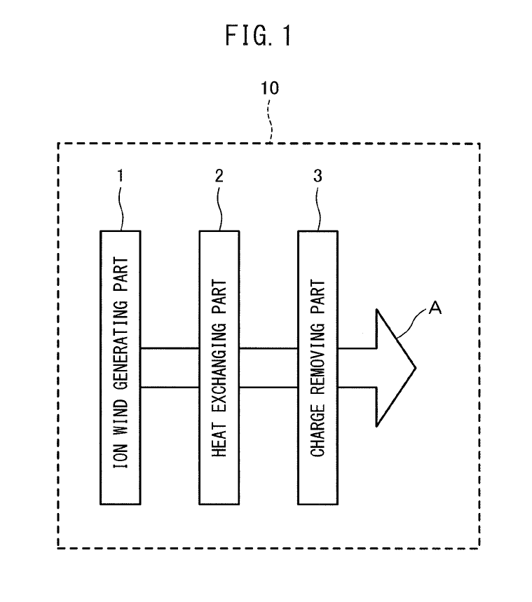

FIG. 1 is a schematic view of the configuration of a heat exchanger 10 according to an embodiment of the present disclosure.

The heat exchanger 10 according to the present embodiment comprises an ion wind generating part 1, heat exchanging part 2, and charge removing part 3.

The ion wind generating part 1, as shown in FIG. 1 by the arrow A, is configured to be able to generate an ion wind having directionality charged positive or negative toward the front surface of the heat exchanger 10. The configuration of the ion wind generating part 1 is not particularly limited, but, for example, it is possible to generate a potential difference between the pair of electrodes to generate a corona discharge or barrier discharge in the air and thereby generate ion wind having directionality charged positive or negative toward the heat exchanger 10. Further, for example, it is also possible to configure the ion wind generating part 1 so as to generate an ion wind by generating ions at a location where there is a flow of air existing in advance such as running wind.

The heat exchanging part 2 is for example a radiator or condenser provided with a tube or other coolant passage through which a coolant flows. The heat exchanging part 2 is configured so as to enable heat exchange with the gas passing through the surroundings of the coolant passage from the front surface to the back surface (right side from left side in FIGURE).

Normally, due to the viscosity of the fluid, the speed of the fluid flowing over the surface (boundary layer) of the coolant passage tends to fall from the speed of the main flow flowing around the coolant passage, but in the present embodiment, it is possible to make the ion wind generated at the ion wind generating part 1 strike the heat exchanging part 2 when running the ion wind so as to suppress a drop in the flow rate at the boundary layer compared with when running air. For this reason, it is possible to improve the efficiency of heat exchange at the heat exchanging part.

However, if configuring the heat exchanger so as to exchange heat with the ion wind, the ion wind exchanged in heat with the heat exchanging part 2 flows from the back surface of the heat exchanging part 2 to the back of the heat exchanging part 2. For this reason, if there is some sort of part present at the back of the heat exchanging part 2, that part is struck by the ion wind and charge is gradually built up.

In particular, if mounting the heat exchanger in a car etc., since it is necessary to mount various car mounted components other than the heat exchanger at the limited space, a charge easily builds up at the car mounted components present behind the heat exchanging part 2. Further, a charge is liable to build up at the car body as well. Further, if a charge builds up at a car mounted component, the electronic components built into the car mounted part are liable to malfunction. Further, if charge builds up at the car body, static electricity is liable to be generated.

Therefore, in the present embodiment, a charge removing part 3 for electrically neutralizing the ion wind flowing from the back surface of the heat exchanging part 2 to the back of the heat exchanging part 2 is provided at the back of the heat exchanging part 2. That is, the heat exchanging part 2 is arranged at the upstream side in the direction of flow of the ion wind shown by the arrow A and the charge removing part 3 is arranged at the downstream side.

As the charge removing part 3, for example, it is possible to use a grounded conductor. Due to this, if the ion wind strikes the conductor, a charge is transferred between the positively or negatively charged ion wind and the conductor, so it is possible to electrically neutralize the ion wind. Therefore, it is possible to keep a part present behind the heat exchanging part 2 from being struck by the ion wind passing through the heat exchanging part 2 and a charge from building up.

The shape of the conductor is not particularly limited, but for example the conductor is preferably made a mesh shape such as a metal mesh or punching metal or the conductor is preferably provided with a plurality of through holes running along the direction of flow of the ion wind. Due to this, it is possible to run ion wind from which the charge is removed by the conductor (that is, air) to the back of the conductor as is, so it is possible to keep the flow of ion wind flowing from the front surface to the back surface of the heat exchanging part 2 from being obstructed by the conductor.

Further, as the charge removing part 3, in addition to a grounded conductor, a conductor carrying a charge of an opposite sign to the ion wind can be used. That is, when using an ion wind generator to generate a positively charged ion wind, it is possible to use a negatively charged conductor as the charge removing part 3, while when using an ion wind generator to generate a negatively charged ion wind, it is possible to use a positively charged conductor as the charge removing part 3.

Even if configuring the charge removing part 3 in this way, the charge is transferred between the ion wind and the conductor, so it is possible to electrically neutralize the ion wind.

Further, by making the conductor carry a charge of an opposite side to the ion wind, it is possible to draw the ion wind to the conductor side, so it is possible to lower the ratio of the ion wind ending up dispersing without contacting the conductor. For this reason, it is possible to improve the charge removing efficiency of the ion wind.

In particular if making the conductor a mesh shape etc., the ratio of ion wind ending up flowing as is to the back of the conductor without contacting the conductor and without being stripped of static electricity by the conductor is liable to increase, but by making the conductor carrying a charge opposite in sign to the ion wind, it is possible to draw the ion wind to the conductor side. For this reason, it is possible to keep the flow of ion wind from being obstructed by the conductor while improve the charge removing efficiency of the ion wind.

The heat exchanger 10 according to the embodiment explained above comprises an ion wind generating part 1 configured to generate an ion wind having directionality charged positive or negative, a heat exchanging part 2 provided at an upstream side in the direction of flow of the ion wind and configured to exchange heat with the ion wind, and a charge removing part 3 provided at a downstream side in the direction of flow of the ion wind and configured to electrically neutralize the ion wind exchanged in heat with the heat exchanging part 2.

Due to this, it is possible to neutralize the ion wind exchanged in heat with the heat exchanging part 2, that is, the ion wind passing through the heat exchanging part 2, to keep the ion wind from striking a part present behind the heat exchanging part 2. For this reason, it is possible to keep a charge from building up at a part present behind the heat exchanging part 2.

As the charge removing part 3, it is possible to use a conductor connected to the ground or a conductor carrying a charge of an opposite sign to the ion wind. In particular, if using a conductor carrying a charge of an opposite sign to the ion wind as the charge removing part 3, it is possible to draw the ion wind to the conductor, so it is possible to lower the ratio of the ion wind ending up dispersing without contacting the conductor. For this reason, it is possible to improve the charge removing efficiency of the ion wind.

Further, by making the conductor a mesh shape or a shape having through holes running along the direction of flow of the ion wind, it is possible to keep the flow of the ion wind from being obstructed by the conductor.

Above, an embodiment of the present disclosure was explained, but the above embodiment only shows part of the examples of application of the present disclosure and is not meant to limit the technical scope of the present disclosure to the specific configuration of the above embodiment.

1. A heat exchanger comprising:
an ion wind generating part configured to generate an ion wind having directionality charged positive or negative;
a heat exchanging part provided at an upstream side in the direction of flow of the ion wind and configured to exchange heat with the ion wind; and
a charge removing part provided at a downstream side in the direction of flow of the ion wind and configured to electrically neutralize the ion wind exchanged in heat with the heat exchanging part.

2. The heat exchanger according to claim 1, wherein the charge removing part is a conductor connected to the ground.

3. The heat exchanger according to claim 1, wherein the charge removing part is a conductor carrying a charge of an opposite sign to the ion wind.

4. The heat exchanger according to claim 2, wherein the conductor is made a mesh shape or a shape having through holes running along the direction of flow of the ion wind.
